(19) United States
(12) Patent Application Publication
(10) Pub. No.: US 2008/0073373 A1
(43) Pub. Date: Mar. 27, 2008

(54) Automatic Machine For The Renting And Sale Of Durable Goods And/Or Food Products

(76) Inventor: Giovanni Vicentin, Brendola-Vicenza (IT)

Correspondence Address: HEDMAN & COSTIGAN P.C., 1185 AVENUE OF THE AMERICAS, NEW YORK, NY, 10036, US

(21) Appl. No.: 11/887,059

(22) PCT Filed: Mar. 24, 2006
(86) PCT No.: PCT/EP2006/002940

§ 371 Date: Oct. 24, 2007

(30) Foreign Application Priority Data
Mar. 25, 2005 (IT) VI2005A000086

(51) Int. Cl. G07F 11/16; G07F 7/00

(52) U.S. Cl. 221/210

(57) ABSTRACT

An automatic machine for the rent and sale of durable goods such as for example VHS videotapes, DVDs, audiotapes, CDs, etc., and/or other food products, such as cigarettes, sweet and savoury snacks, drinks, etc., comprising at least two openings or apertures for product insertion/dispensing (14, 15) of which one opening can be used for rental products, and the other for sold products, and means adapted to block the container or tray (6) on which the product is placed, during the purchasing step of a product; the machine also includes an electromechanical system, adapted to prevent the user, during the retrieval step of the requested product, from accessing the supply stock (4) of the machine, illegally removing the products contained therein.

The present invention relates to an automatic machine for the renting and sale of durable goods, such as audiotapes, videotapes, CDs, DVDs, etc and/or food products such as snacks, drink containers, etc.

In particular, the invention relates to an automatic machine for renting and sale of durable goods and/or food products, adapted to “block” the container on which the “good” is positioned during the purchase operation of said “good”, and by means of an electromechanical system, adapted to prevent the user from any possible access to the machine interior, either using his hands or some other system, during the extraction of the requested product, to ensure that products in the machine cannot be removed illegally.

Automatic machines for renting and selling various items such as durable goods (books, videotapes, audiotapes, CDs, DVDS, etc) and/or food products (such as automatic distributor machines for cigarettes, sweet and savoury snacks, sandwiches, ice-creams, drinks in general, etc.) are well known and very common.

More specifically, there is a vast range of automatic machines for selling drinks, sandwiches and/or snacks, wherein the various products are placed inside a supply stock system stacked in columns visible to the end buyer, due to the use of a transparent front door, so that the abovesaid buyer can make his choice.

Each product is generally contained inside a support element identified by an alphanumerical code that must be entered by the buyer on a control panel located outside the machine after having paid for the product to make the desired choice; in that case the chosen item is released and dropped into a receptacle for removal.

However, the glass structure of the front door and the considerable access available in the area for product removal make such machines extremely vulnerable in that illegal removal of the items and vandalism in general is relatively easy.

On the other hand, automatic rental and vending machines for durable goods such as videotapes, audiotapes, CDs, DVDs, etc. are also known; they are substantially composed of a keyboard and a screen available for the customer to select the required product, plus an insertion/dispensing slot through which an item can be inserted when returned and/or collected after rental or purchase payment of an established amount, or after payment by inserting a pre-paid card.

The internal structure of such machines is organised so that once the command has been entered on the keyboard by the customer, a gripper device associated with a, trolley is moved to retrieve the selected item in supply stock and to present it at the dispenser slot (in the case where a product is being rented or sold) or vice versa (in the case where the product is being returned).

Traditional automatic machines used for the renting and vending of durable goods such as VHS, CDs, DVDS, etc are also extremely vulnerable to illegal product removal by vandalism; moreover, given the complementary potential of the products (VHS, CDs, DVDs, on one hand and cigarettes, snacks, sandwiches, and drinks on the other) it has become increasingly more necessary to use this type of machine also as an automatic distributor for food products such as snacks, sandwiches, ice-creams, and drinks in general, while protecting the machine against vandalism or stealing by the user.

Therefore the aim of the present invention is to provide an automatic vending machine for the sale or renting of durable goods and/or food products, that permits the distribution by the same machine of items such as books, VHS videotapes, audiotapes, CDs, DVDS, etc., as well as food products such as cigarettes, snacks, drinks, sandwiches, ice-creams, etc.

Another aim of the present invention is to provide an automatic machine for the sale or renting of durable goods and/or food products, that is able, during product purchase step, to block the receptacle in which the item is placed, so that it can be recovered and used again during a further purchasing operation.

A further aim of the present invention is to provide an automatic machine for the sale or renting of durable goods and/or food products, that is structured so that during the retrieval of the selected item, it will prevent the user from accessing the interior of the machine with his hand or some other means in order to illegally remove products contained inside the machine. Such aims are achieved by an automatic machine for the sale and renting of durable goods and/or food products, according to the appended claim 1 to which reference is made.

Further aims and advantages of the present invention will be made clear by the following description and the appended drawings, provided simply as explanatory, but non-limiting examples wherein:

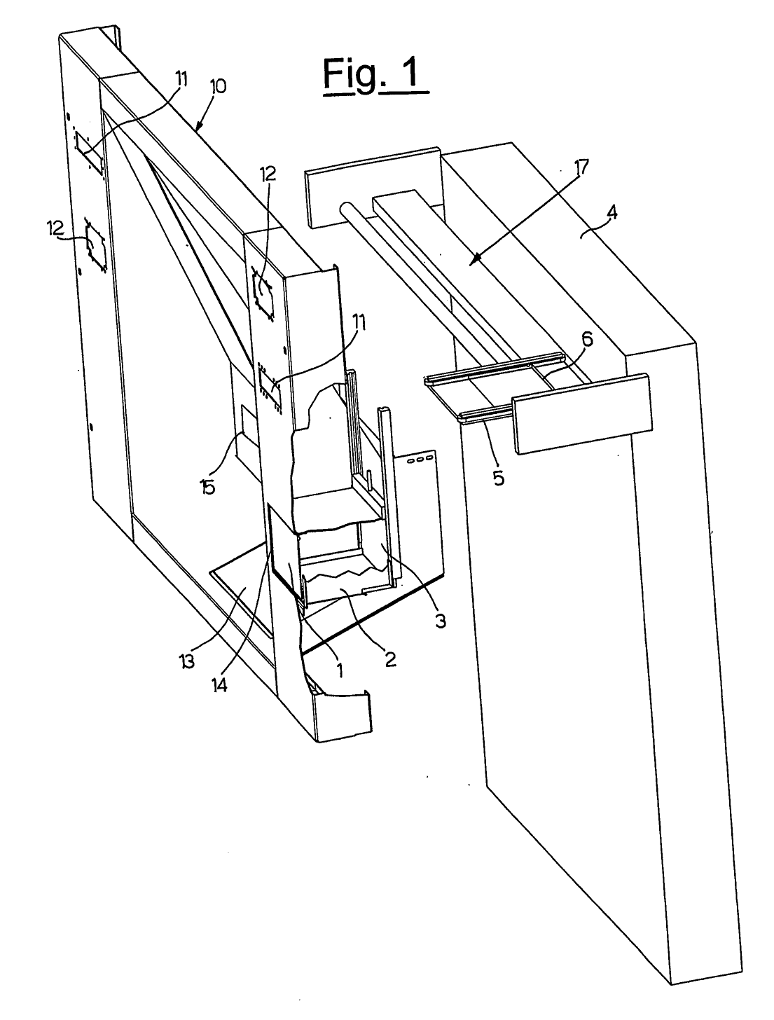

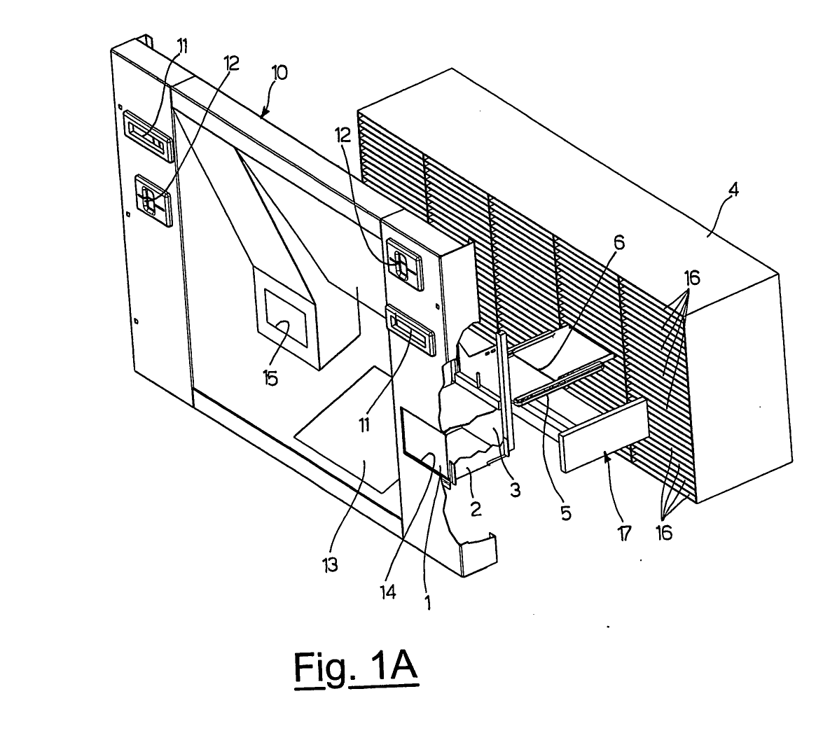

FIG. 1 shows a partially exploded perspective view of the automatic machine for the sale or renting of durable goods and food products during a first operating step of product removal, according to the present invention;

FIG. 1A is a perspective view of a detail of the automatic machine shown in FIG. 1 during the operating step of product removal, according to the present invention;

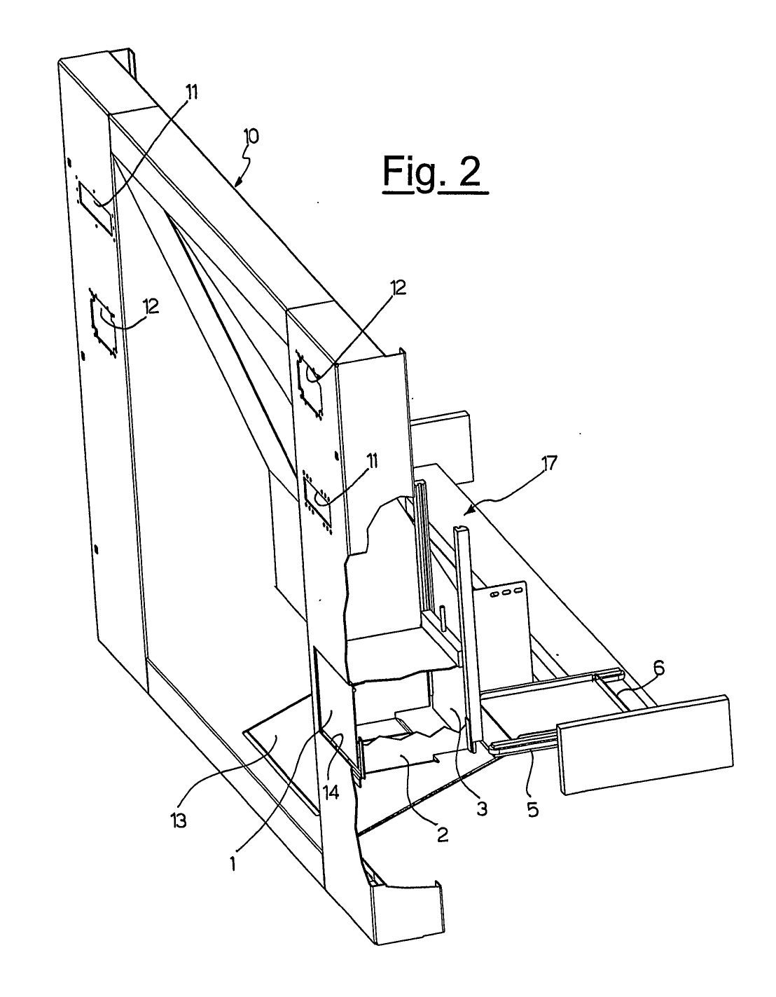

FIGS. 2, 3, 4, 4A and 5 show the same number of partial perspective views of the automatic machine shown in FIG. 1 during a second operating step of product release, according to the present invention;

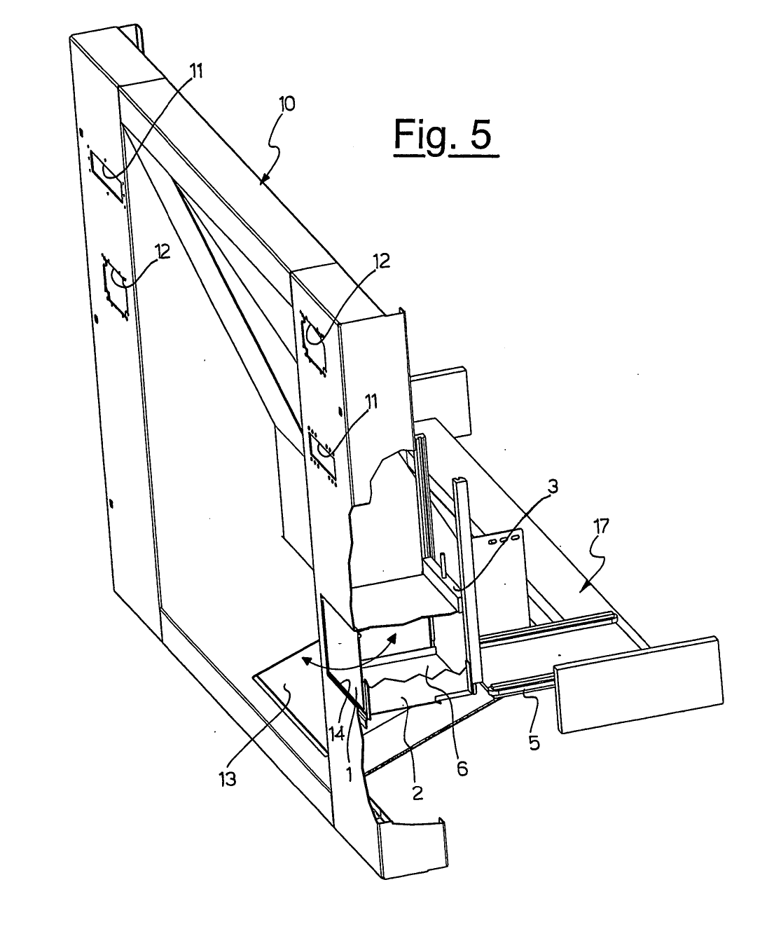

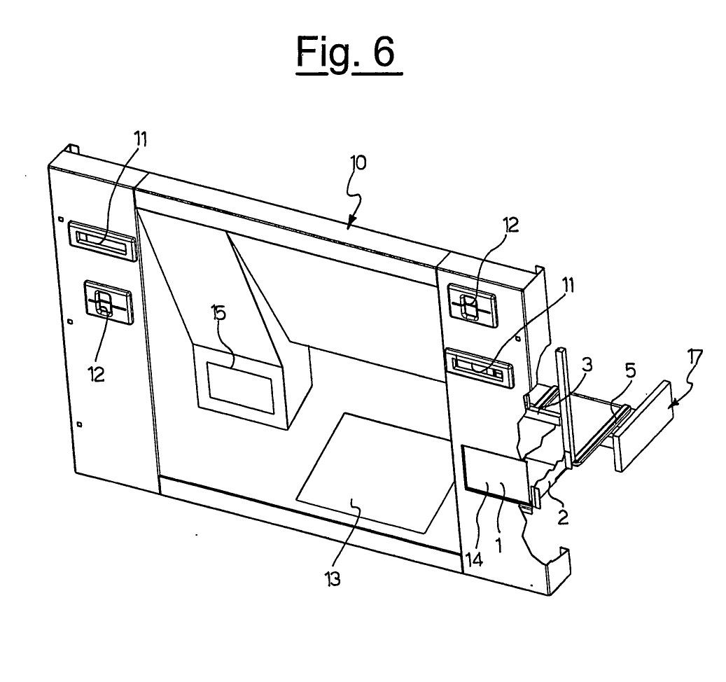

FIG. 6 is a partially front view of the automatic machine shown in FIG. 1 during the operating step of product release, illustrated in particular in FIG. 5, according to the present invention.

With reference to the figures mentioned, the automatic machine for the sale and renting of durable goods and food products according to the present invention, comprises a specifically shaped control panel or terminal 10, at the user's disposal, which in turn includes one or more slots 11, adapted for the insertion of prepaid cards for the payment of the pre-selected items, one or more token or coin boxes 12 for cash payment of the desired items, and at least one screen 13, either of the “touch-screen” type or equipped with an external keyboard for the selection and purchase of the desired item.

In relation to this aspect it is also possible to provide the use of a set of images and/or photos of the various products available in pre-established zones on terminal 10, to permit product selection.

The specifically shaped control panel 10 also provides a first opening or aperture 14, for the dispensing of the product on sale, and at least a second opening or aperture 15 for the insertion or dispensing of rental products.

The automatic machine also contains an alveolar structure that forms the supply stock 4 of the products for sale and/or rent, composed of a set of compartments 16, of various sizes, depending on the size of the product to be contained in each compartment.

In particular, according to the present invention, the products typically destined for renting, such as VHS videotapes, audiotapes, CDs, DVDs, etc., are positioned directly in a set of predetermined compartments 16, while the products for sale, such as typically snacks, drinks, ice-creams, cigarettes, etc., are placed on a tray 6, that is positioned inside each compartment 16 of the supply stock 4.

On the other hand, the products destined for renting are positioned directly in the predetermined compartments 16 of the supply stock 4, without the support of the tray 6.

Retrieval of the durable goods and/or food products, whether on sale, or for rental purposes, is performed by means of a specifically shaped gripper 5, which moves in a horizontal direction along a slide 17, which in turn travels in a vertical direction along the complete supply stock 4, in order to be able to retrieve and present at the dispenser openings 14, 15, the products located in any one of the compartments 16 in supply stock 4.

By means of a step motor action controlled by an electronic piloting system, the gripper 5 adapts its own size in length and width to correspond with the item or tray 6 that it must retrieve from inside each compartment 16 in supply stock 4.

As far as the retrieving and dispensing modes for rented durable goods are concerned such as VHS, CDs, DVDs, etc., the automatic machine operation is substantially very similar to a traditional type machine, since in this case, the gripper 5 retrieves the selected product from inside the pre-established compartment 16 in supply stock 4, and presents it at the dispenser opening 15 at the user's disposal; such dispenser opening can be positioned at the front of the supply stock 4, or can be installed lower down so that the dispensing of the product outside the machine occurs through gravity drop into a collector receptacle.

In a similar manner, the rental products can be returned by insertion into opening 15, where the gripper 5 will be moved to retrieve the products and replace them in the pre-established compartments 16 of the supply stock 4.

For food product purchase, also dispensed by the machine in question, the operational function is performed substantially as follows.

First, the user requests the purchase of the product of his choice by selecting on the control panel 13.

The gripper 5 travels to align itself with the compartment 16 of the supply stock 4, which contains such product and picks up the tray 6 bearing the product, then the gripper 5 moves to the retrieval and dispensing zone (FIG. 2).

The product retrieval zone includes an external hatch 1, a connecting tunnel 2, and an internal hatch 3; during the step wherein the gripper 5 approaches the retrieval zone, both the external hatch 1 and the internal hatch 3 are closed, as shown in detail in FIG. 2.

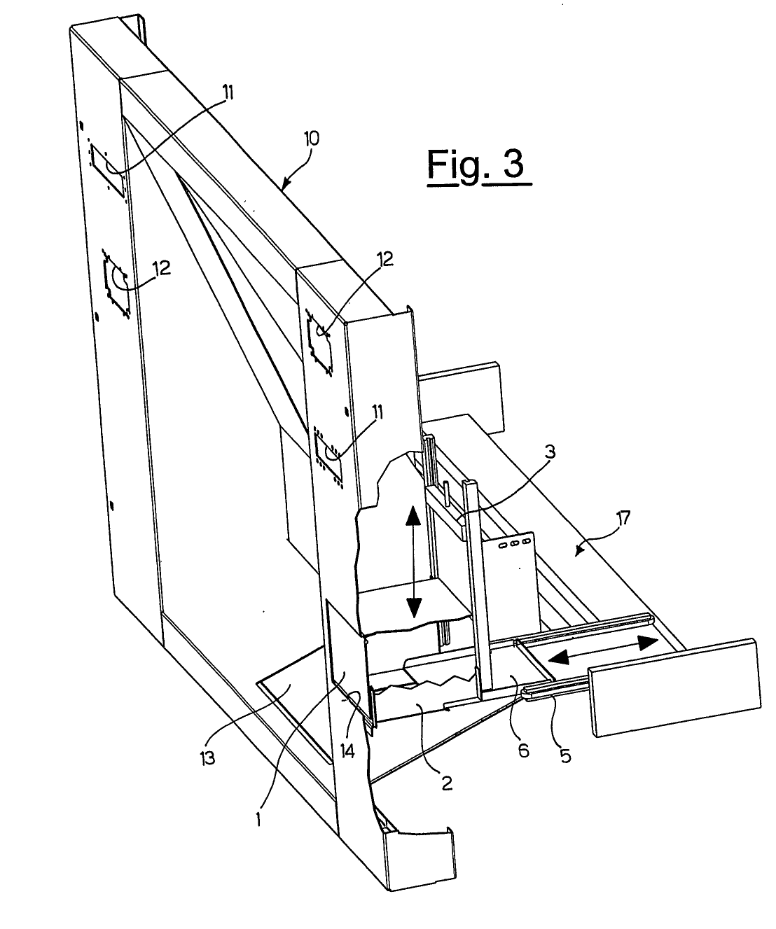

After it has been positioned in alignment with the internal hatch 3, the gripper 5 waits until the hatch is opened (FIG. 3), and at this point, it passes the tray 6 on which the selected product is positioned, inserting it into the connecting tunnel 2; during this step the external hatch 1 remains closed.

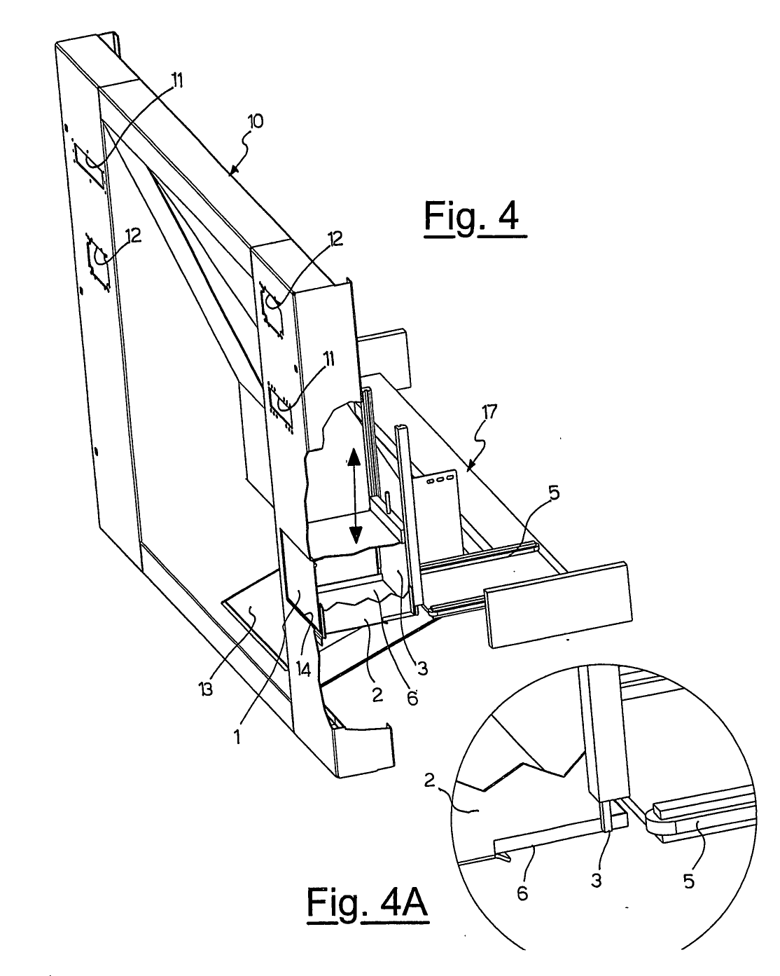

Subsequently, once the tray 6 has reached an established position inside the connecting tunnel 2, the internal hatch 3 closes (FIG. 4) fitting itself in a seat made on the tray 6 (FIG. 4A) and becoming fixedly engaged with the above said tray (6). This makes it impossible for a user to extract the tray 6 from the exterior through the external hatch 1.

At this point, the external hatch 1 is unblocked (FIG. 5) permitting the user to pick up only the selected product on the tray 6, without the possibility of extracting the tray 6, since the tray 6 is blocked by the internal hatch 3. Since the hatch 3 is closed, it also prevents the products in the supply stock 4 inside the automatic machine from being illegally removed.

Lastly, after the user has retrieved the product from the external hatch 1, the external hatch 1 will close again, followed by the opening action of the internal hatch 3, and the gripper 5 is able to pick up the empty tray and replace it in the relative compartment 16 in the supply stock 4.

In this manner, by using the machine according to the invention it is possible to use the same structure to dispense durable goods such as books, VHS videotapes, audiotapes, CDs, DVDs, etc., as well as food products such as cigarettes, snacks, drinks, sandwiches, ice-creams, etc.

Furthermore, the aforesaid machine is also able to block the container on which the aforesaid product is placed, during the purchasing step of the food product, so that it can be recovered and used again during a later purchasing operation, and at the same time, is able to prevent the user from access into the machine with his hand or other means during the retrieval step of the requested product, stopping any possibility of stealing the products contained in the machine.

The characteristics of the automatic machine for the rent and sale of durable goods and/or food products, subject of the present invention, are clear through the aforesaid description, as are the obvious advantages.

Lastly, it is clear that numerous other variants can be applied to the automatic machine in question, while remaining within the innovative concept of the invention, just as it is also clear that in the practical embodiment of the invention, all functions, materials, forms, and dimensions of the illustrated details can be of any kind according to necessity and can therefore be replaced by other elements technically equivalent.

1. Automatic machine for the rent and sale of durable goods and/or food products, of the type comprising a terminal or control panel (10) to be used to select and/or purchase at least one product by a user, at least one supply stock (4) where the products for rent and for sale are contained, and at least one specifically shaped gripper (5), adapted to retrieve, transport and release of the product, characterised in that said machine provides for means adapted to block, at least one support element (6) on which said product is positioned, during the product purchase and/or rental step.

2. Automatic machine according to claim 1 characterised in that said machine further comprises an electromechanical system adapted to prevent the user from possible access into said supply stock (4) during the retrieval step of the requested product, illegally removing the products contained therein.

3. Automatic machine according to claim 1 characterised in that said terminal (10) provides means for payment (11, 12) of the selected products, and at least one screen (13) for choosing and purchasing one or more desired products.

4. Automatic machine according to claim 1 characterised in that said supply stock (4) consists of an alveolar structure and is made up of a plurality of compartments (16) of various sizes, according to the size of the product each compartment must contain.

5. Automatic machine according to claim 1 characterised in that said terminal (10) presents at least two openings or apertures (14, 15) for the introduction and/or dispensing of the rented and/or sold products, wherein at least one first opening (15) can be used for rental products, and at least a second opening (14) can be used for products on sale.

6. Automatic machine according to claim 1 characterised in that said specifically shaped gripper (5) travels in a horizontal direction along a slide (17), which in turn, travels vertically through the total supply stock (4) in order to retrieve and present the products for rent and/or for sale, at said openings (14, 15), said specifically shaped gripper (5) being also apt to adapt its own dimensions in length and width according to the product and/or said support element (6) by means of an electromechanically controlled system.

7. Automatic machine according to claim 4 characterised in that the products destined for rent, such as VHS videotapes, audiotapes, CDs, DVDs, etc., are each positioned directly inside a pre-established compartment (16), while the products for sale, such as food products such as snacks, drinks, ice-creams cigarettes, etc., are positioned on said support element (6) which is previously inserted inside each compartment (16) of the supply stock (4).

8. Automatic machine according to claim 1 characterised in that it presents at least one opening (14) for the dispensing of rental and/or sales products, equipped with at least one external hatch (1) that communicates with the exterior, permitting the user to retrieve the selected product, and at least one connecting tunnel (2) that connects said external hatch (1) with at least one internal hatch (3), said external hatch (1) and internal hatch (3) being normally closed when not operating.

9. Automatic machine according to claim 8 characterised in that during the rental or sales step, said external hatch (1) remains closed, while said internal hatch (3) is opened to permit the insertion of said support element (6) on which the selected product is placed, which is inserted into said connecting tunnel (2).

10. Automatic machine according to claim 9 characterised in that once said support element (6) of the selected product has reached an established position inside said connection tunnel (2), said internal hatch (3) is closed and is fitted in at least one specifically shaped seat of said support element (6), so that the hatch is fixedly engaged with said support element (6) thus preventing the extraction of the support element from the exterior, said external hatch (1) thus being unblocked and being openable by the user to retrieve only the selected product, and once the selected product has been removed by the user, said external hatch (1) being adapted to close again and then said internal hatch (3) to open.
